(19) United States
(12) Patent Application Publication
(10) Pub. No.: US 2005/0265778 A1
(43) Pub. Date: Dec. 1, 2005

(54) Concealed-type leg tube structure

(76) Inventor: Ren-Ju Tzeng, Changhua Hsien (TW)

Correspondence Address: RABIN & BERDO, P.C., Suite 500, 1101 14th Street, N.W., Washington, DC, 20005, US

(21) Appl. No.: 10/856,764

(22) Filed: Jun. 1, 2004

(51) Int. Cl. F16B 12/44; F16B 9/00

(52) U.S. Cl. 403/231

(57) ABSTRACT

A concealed-type leg tube structure, each vertical leg tube has several wide-side locating holes at the upper extent and several narrow-side locating holes at the upper extent that enable conjoinment via matching union blocks having respectively aligned holes and openings. Each union block has the holes disposed in the wide side, with the openings formed in a plurality along the narrow side. Additionally, the vertical leg tube wide-side locating holes are aligned with connector block holes for fastening by means of screws and the vertical leg tube narrow-side locating holes are aligned with the connector block holes for fastening by means of screws. Each connector block has several holes in the two ends, with threaded holes in the center at one side of the connector block, thereby enabling the insertional conjoinment of the horizontal tubes and the connector blocks.

### BACKGROUND OF THE INVENTION

1) Field of the Invention

The invention herein relates to a concealed-type leg tube structure in which connectors are hidden within the interior section to enhance exterior appearance.

2) Description of the Prior Art

Refer to FIG. 1 and FIG. 2, the exploded and the isometric drawing of the prior art. The prior art utilizes a connector block A to attach the leg tube B, the said connector block A consisting of four small squares A1 that provide for conjoinment (as shown in FIG. 1), enabling the sleeving of the leg tube B onto the connector block A and its fastening thereon with screws C. Such a method of assembly exposes some of the squares A1 on the viewable exterior (as shown in FIG. 2). If the said connector block A were fabricated of plastic, it would differ noticeably from the color of the leg tube B and seriously affect the exterior attractiveness, which is among the drawbacks of the said prior art.

Refer to FIG. 3 and FIG. 4, the exploded and the isometric drawing of another prior art. In this prior art, U-shaped enslotting elements D are welded to the two sides at the upper extent of the leg tube E, enabling the horizontal tube F to be docked onto the U-shaped enslotting elements D and, furthermore, fastened with screws G to achieve a entire leg tube assembly structure. However, poor welding often occurs when the U-shaped enslotting elements D are welded to the leg tube E, causing the U-shaped enslotting elements D and the leg tube E to become set aslant or to conjoin unevenly, with these drawbacks resulting in unusable leg tubes E that cannot be adjusted and, furthermore, good quality leg tube E production rate decreases, which directly affects overall exterior attractiveness. Additionally, the U-shaped enslotting elements D are steel components that raise production costs, which is among the shortcomings of the said prior art.

Therefore, the applicant of the invention herein, engaged in the shelf manufacturing industry for many years, became aware of the various shortcomings of leg tubes and conducted prolonged research based on the experience accumulated, which culminated in the successful development of the concealed-type leg tube structure of the present invention.

### SUMMARY OF THE INVENTION

The objective of the invention herein is to provide a concealed-type leg tube structure in which connectors are hidden within the interior section to enhance exterior appearance, wherein each vertical leg tube has several wide-side locating holes at the upper extent and several narrow-side locating holes at the upper extent that enable conjoinment via matching union blocks having respectively aligned holes and openings. Each union block has the holes disposed in the wide side, with the openings formed in a plurality along the narrow side. Additionally, the vertical leg tube wide-side locating holes are aligned with connector block holes for fastening by means of screws and the vertical leg tube narrow-side locating holes are aligned with the connector block holes for fastening by means of screws. Each connector block has several holes in the two ends, with threaded holes in the center at one side of the connector block, thereby enabling the insertional conjoinment of the horizontal tube and the connector blocks.

### BRIEF DESCRIPTION OF THE DRAWINGS

FIG. 1 is an exploded drawing of the prior art.

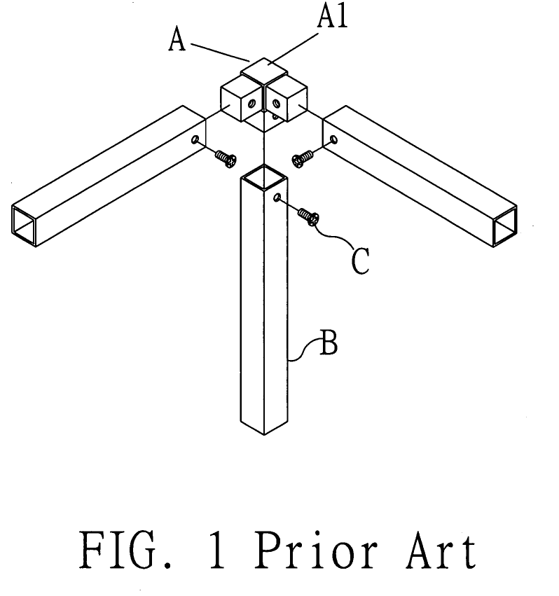

FIG. 2 is an isometric drawing of the prior art.

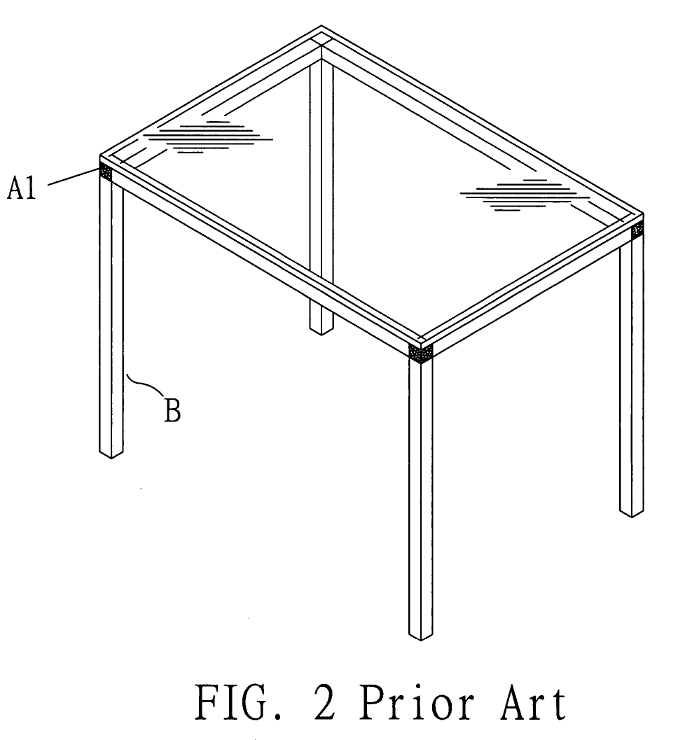

FIG. 3 is an exploded drawing of another prior art.

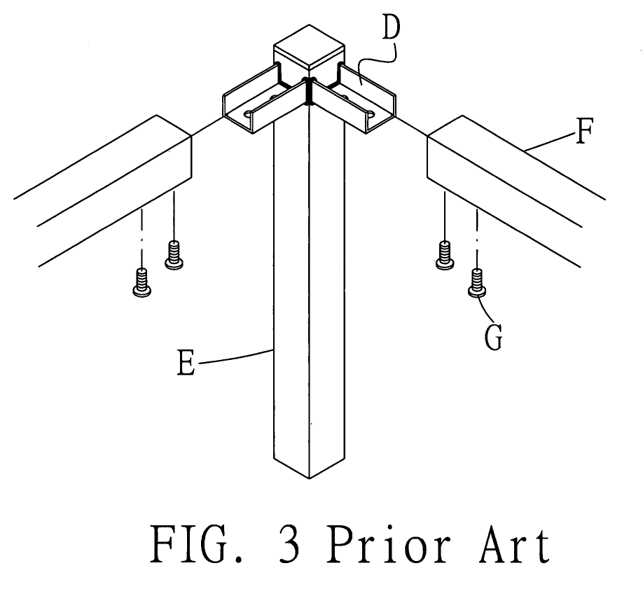

FIG. 4 is an isometric drawing of the other prior art.

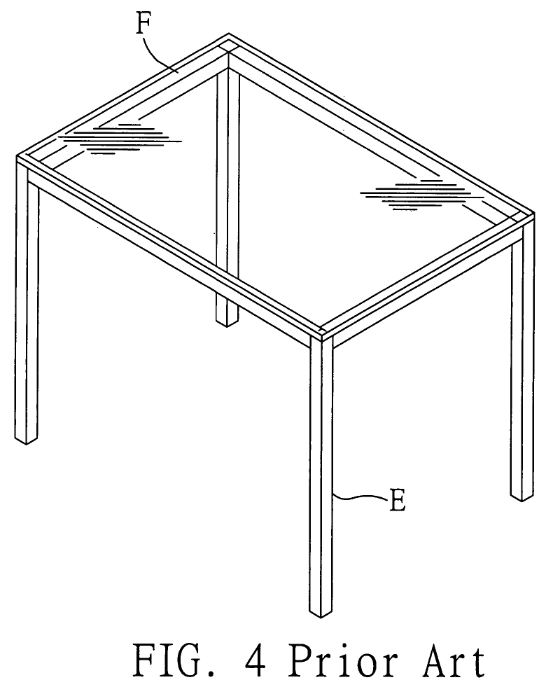

FIG. 5 is an isometric drawing of the invention herein.

FIG. 6 is an exploded drawing of the invention herein.

FIG. 7 is an partial exploded drawing of the invention herein (front leg tube).

FIG. 8 is an partial exploded drawing of the invention herein (rear leg tube).

FIG. 9 is an isometric drawing of an embodiment of the invention herein.

FIG. 10 is an isometric drawing of an embodiment of the invention herein.

FIG. 11 is an isometric drawing of an embodiment of the invention herein.

FIG. 12 is an isometric drawing of an embodiment of the invention herein.

### DETAILED DESCRIPTION OF THE INVENTION

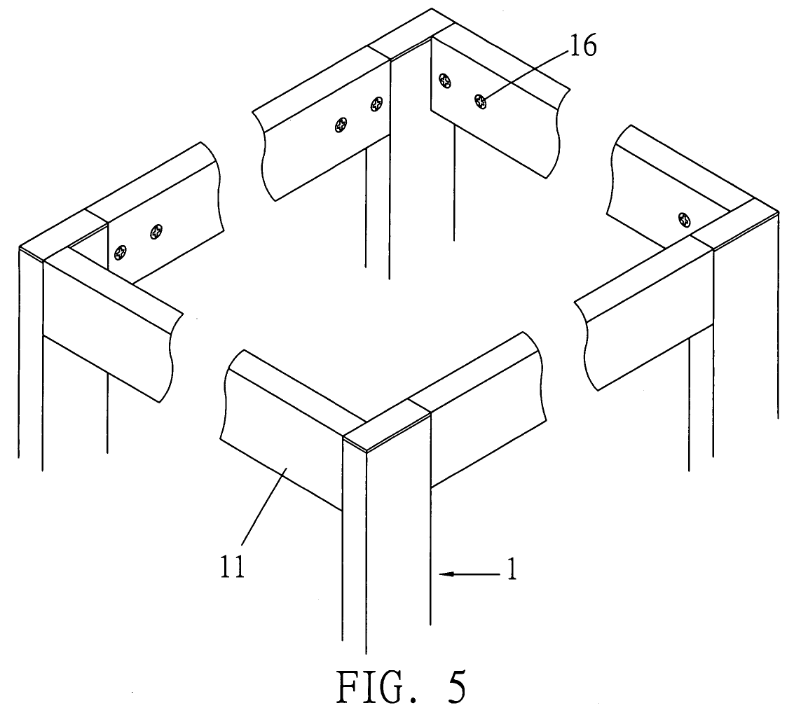

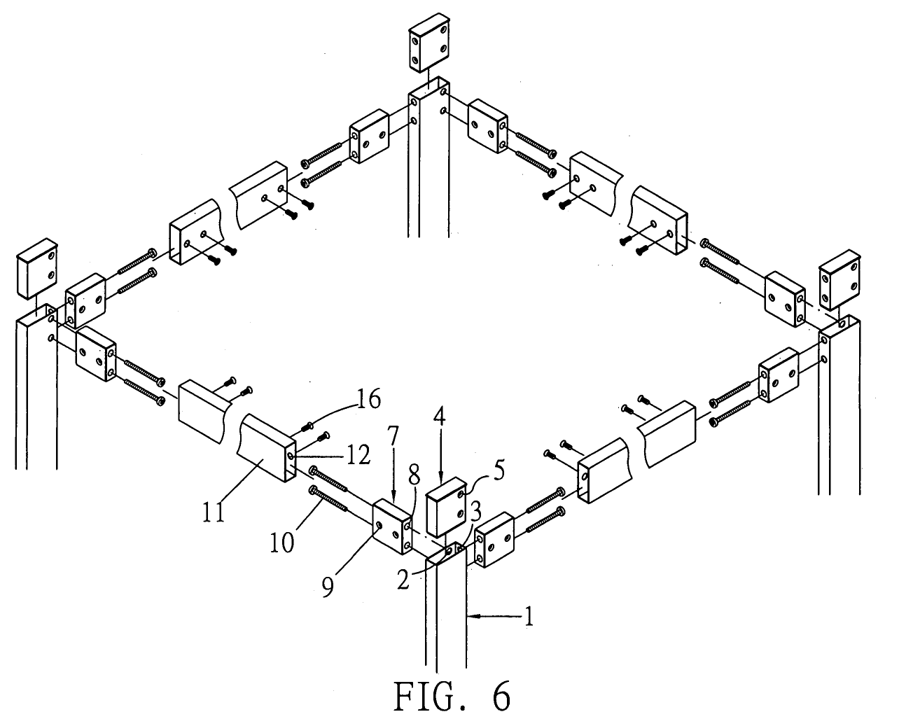

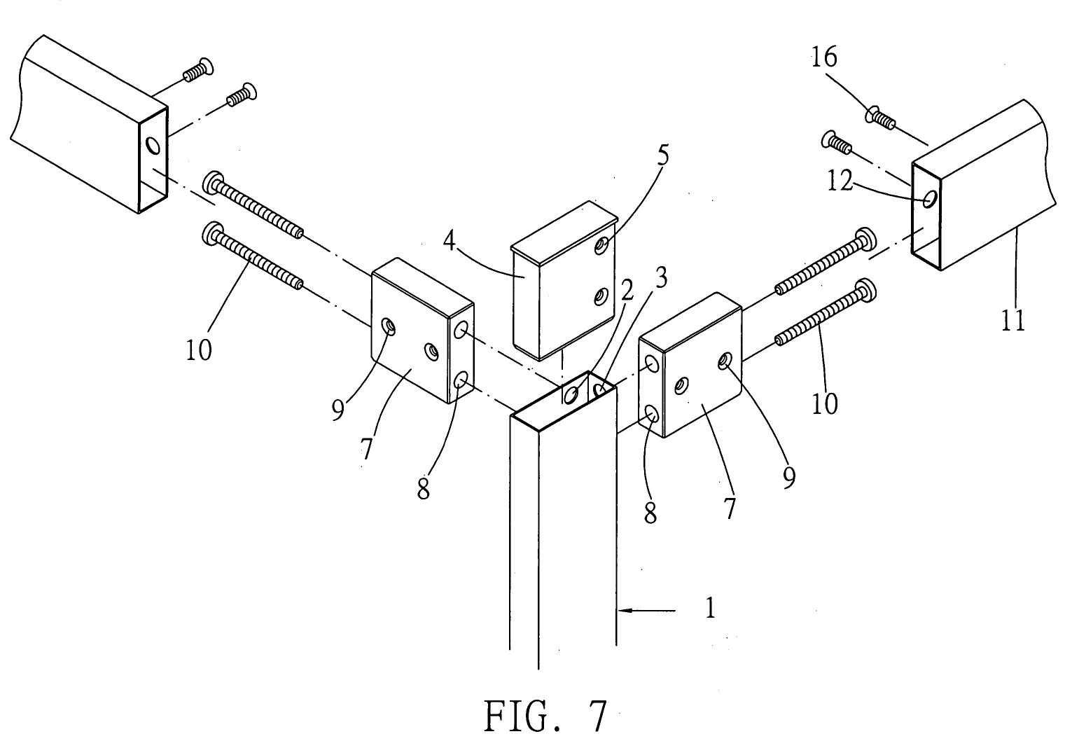

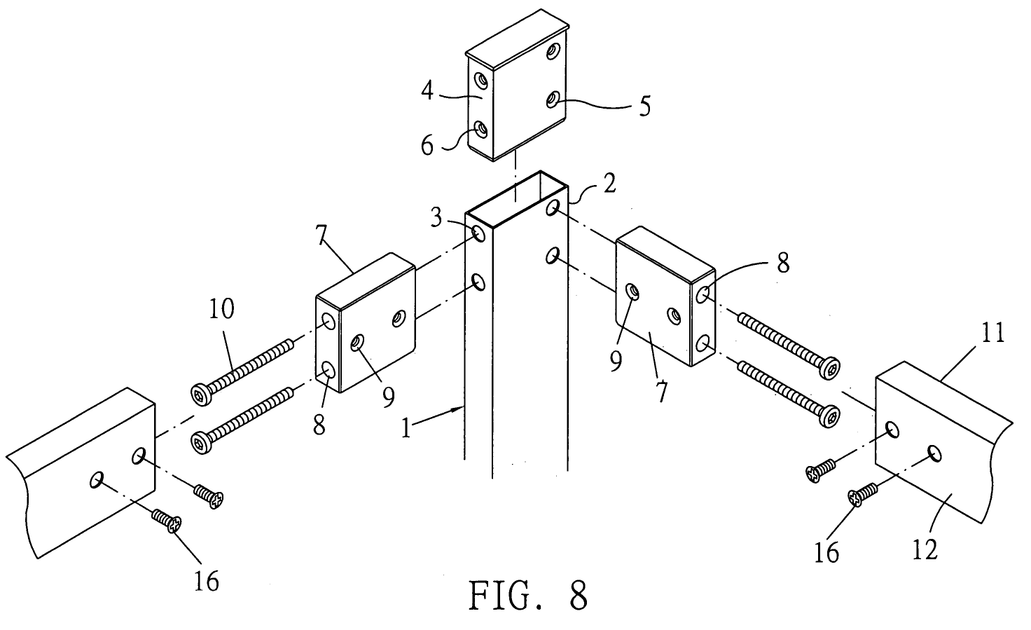

Refer to FIG. 5, FIG. 6, FIG. 7, and FIG. 8, the isometric drawing, the exploded drawing, and the partial exploded drawings of the invention herein.

The concealed-type leg tube structure is comprised of (as shown in FIG. 6): a plurality of vertical leg tubes 1 that are hollow members sequentially interconnected by wide sides and narrow sides into a framework, each said vertical leg tube 1 having several wide-side locating holes 2 at the upper extent and several narrow-side locating holes 3 at the upper extent that enable conjoinment via matching union blocks 4 having respectively aligned holes 5 and openings 6 (as shown in FIG. 7 and FIG. 8, wherein FIG. 7 is the front side leg tube and FIG. 8 is the rear side leg tube); each said union block 4 has the holes 5 disposed in the wide side, with the openings 6 formed in a plurality along the narrow side; additionally, the vertical leg tube 1 wide-side locating holes 2 are aligned with the connector block 7 holes 8 for fastening by means of screws 10 and the vertical leg tube 1 narrow-side locating holes 3 are aligned with the connector block 7 holes 8 for fastening by means of screws 10 (as shown in FIG. 7 and FIG. 8, wherein FIG. 7 is the front side leg tube and FIG. 8 is the rear side leg tube); each said connector block 7 has several holes 8 in the two ends, with threaded holes 9 in the center at one side of the connector block 7 and, as such, the horizontal tube 11 locating holes 12 are aligned with the connector block 7 threaded holes 9 for conjoinment by means of screws 16 fastened at the interior section; a plurality of horizontal tubes 11 each have several locating holes 12 in their two ends and, as such, the assembled structure of the invention herein (as shown in FIG. 5) is capable of completely obscuring indications of conjoinment between the vertical leg tubes 1 and horizontal tubes 11, thereby achieving an overall exterior appearance that is smooth and attractive; additionally, the union blocks 4 and the connector blocks 7 of the invention herein are of plastic construction and, as such, production cost is lower and, furthermore, the union blocks 4 and the connector blocks 7 of the invention herein can be adjusted as required, enabling leg tube stability and levelness.

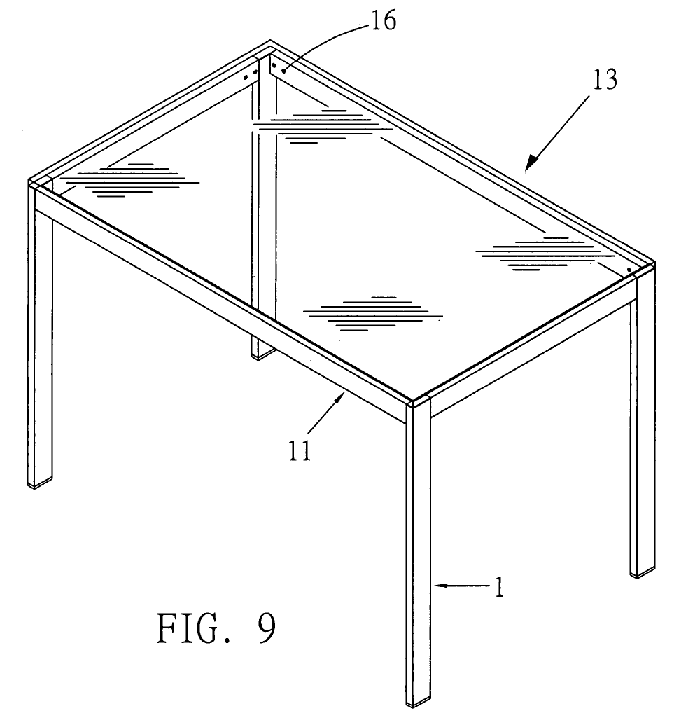

Refer to FIG. 9, the isometric drawing of an embodiment of the invention herein.

The leg tubes of the present invention can utilized for dining table 13 applications, with the connectors not visibly evident, effectively enhancing attractiveness.

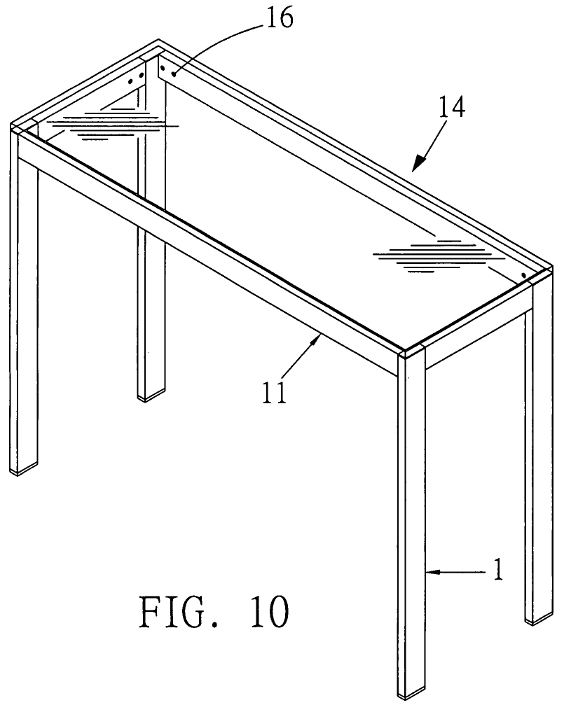

Refer to FIG. 10, the isometric drawing of an embodiment of the invention herein.

The leg tubes of the present invention can utilized for long narrow table 14 applications, with the connectors not visibly evident, effectively enhancing attractiveness.

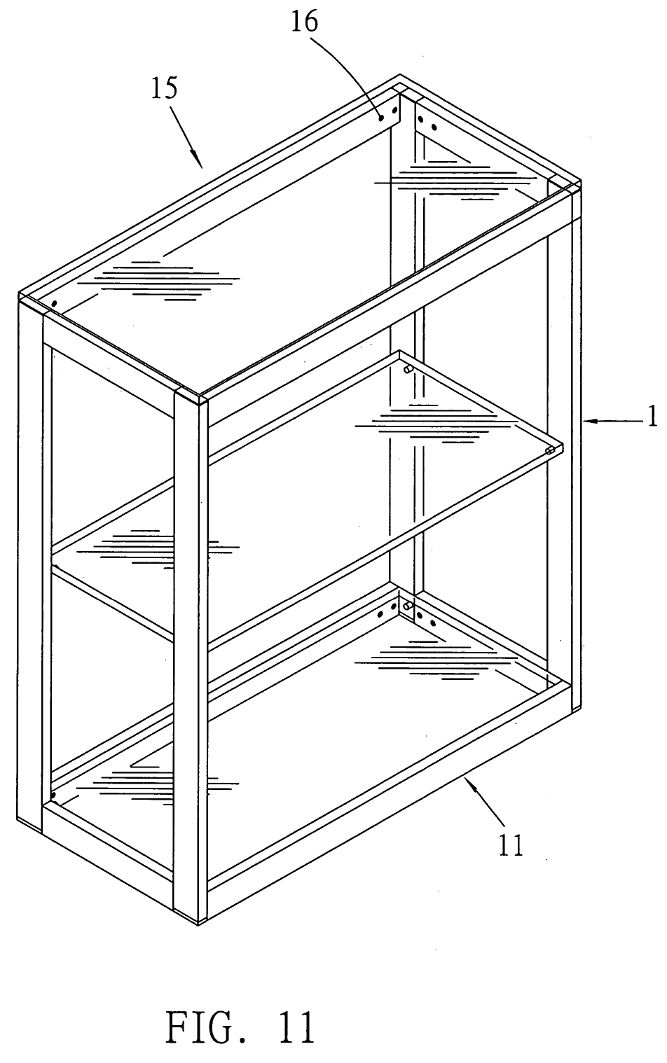

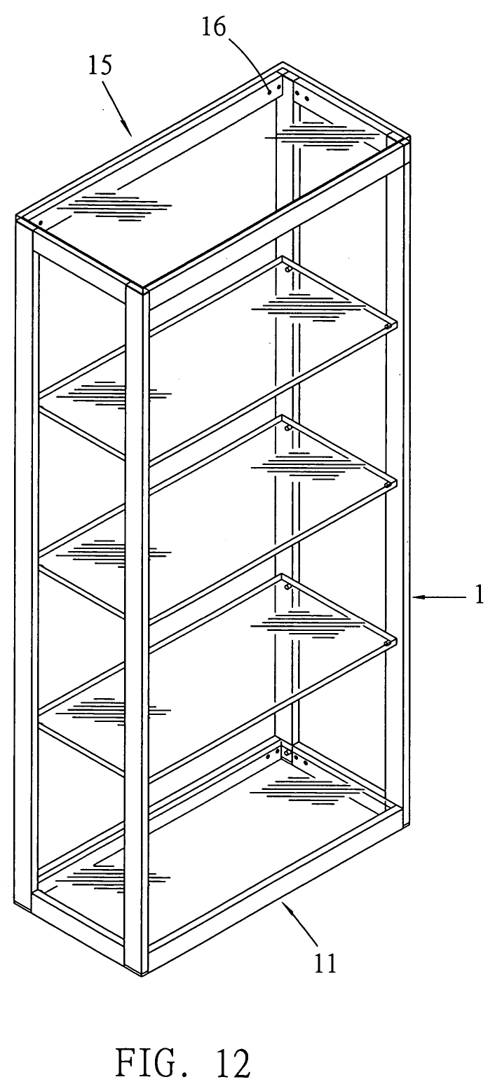

Refer to FIG. 11 and FIG. 12, the isometric drawings of embodiments of the invention herein.

The leg tubes of the present invention can utilized for standalone shelf 14 applications, with the connectors not visibly evident, effectively enhancing attractiveness.

In summation of the foregoing section, since the conjoinment method of the invention herein is not externally apparent and thereby enhances exterior attractiveness, as claimed, and, furthermore, meets the new patent requirement of progressiveness, the present invention is submitted in application for the granting of patent rights.

1. A concealed-type leg tube structure comprised of:
Vertical leg tubes that are hollow members sequentially interconnected by wide sides and narrow sides into a framework, each said vertical leg tube having several wide-side locating holes at the upper extent and several narrow-side locating holes at the upper extent that enable conjoinment via matching union blocks having respectively aligned holes and openings; each said union block has the said holes disposed in the wide side, with the said openings formed in a plurality along the narrow side; additionally, the said vertical leg tube wide-side locating holes are aligned with connector block holes for fastening by means of screws and the said vertical leg tube narrow-side locating holes are aligned with the said connector block holes for fastening by means of the said screws; each said connector block has several holes in the two ends, with threaded holes in the center at one side of the said connector block, thereby enabling the insertional conjoinment of horizontal tubes and the said connector blocks.
Horizontal tubes that each have several locating holes in their two ends.

2. As mentioned in claim 1 of the concealed-type leg tube structure of the invention herein, the said horizontal tubes and the said connector blocks threaded holes are conjoined together by means of screws fastened at the interior section.
